(19) United States
(12) Patent Application Publication
(10) Pub. No.: US 2022/0132358 A1
(43) Pub. Date: Apr. 28, 2022

(54) NETWORK FUNCTION SELECTION FOR INCREASED QUALITY OF SERVICE IN COMMUNICATION NETWORKS

(71) Applicants: AT&T Intellectual Property I, L.P., Atlanta, GA (US); AT&T Mobility II LLC, Atlanta, GA (US)

(72) Inventors: Junan Peng, Bellevue, WA (US); Lan Scott, Redmond, WA (US); Erie Lai Har Lau, Redmond, WA (US)

(73) Assignees: AT&T Intellectual Property I, L.P., Atlanta, GA (US); AT&T Mobility II LLC, Atlanta, GA (US)

(21) Appl. No.: 17/082,783

(22) Filed: Oct. 28, 2020

(51) Int. Cl. H04W 28/02

(52) U.S. Cl. CPC H04W 28/0268; H04W 28/0289

(57) ABSTRACT

Aspects of the subject disclosure may include, for example, selection of network functions in a communication network based on dynamic load and/or location of the network functions. A network repository function may subscribe to receive dynamic load information of network functions and then use the dynamic load information when selecting network functions. The network repository function may also determine a distance between network functions and then use the distance when selecting network functions. Other embodiments are disclosed.

### FIELD OF THE DISCLOSURE

The subject disclosure relates to network function selection in communication networks.

### BACKGROUND

Communication network operators typically agree to provide a guaranteed minimum Quality of Service (QoS) to certain customers. For example, first responders or other high priority customers may be provided a guaranteed minimum QoS in a Service Level Agreement (SLA).

Communication network operators typically implement QoS policies to prioritize some data or voice traffic over other data or voice traffic in an effort to meet the minimum QoS guarantees. In spite of these QoS policies, meeting minimum QoS guarantees remains a challenging problem for communication network operators.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for network function selection based on dynamic load information and/or location of the network function. Other embodiments are described in the subject disclosure.

One or more aspects of the subject disclosure include receiving a network function registration request from each of a plurality of network functions, wherein the network function registration request from each of the plurality of network functions includes information describing a location of each of the plurality of network functions; receiving a discovery request from a control plane network function to discover one of the plurality of network functions, the discovery request including information describing a location of the control plane network function; determining a distance between the control plane network function and each of the plurality of network functions; and in response to the determining the distance, providing an identity of one of the plurality of network functions to the control plane network function.

One or more aspects of the subject disclosure include receiving, by a processing system including a processor, a network function registration request from each of a plurality of network functions; subscribing, by the processing system, to a network service that provides a dynamic load information for each of the plurality of network functions; receiving, by the processing system, the dynamic load information for at least one of the plurality of network functions; receiving, by the processing system, a discovery request from a control plane network function to discover one of the plurality of network functions; selecting, by the processing system, a candidate network function from the plurality of network functions based on the dynamic load information received for the at least one of the plurality of network functions; and providing, by the processing system, an identity of the candidate network function to the control plane network function.

One or more aspects of the subject disclosure include receiving a network function registration request from each of a plurality of network functions, wherein the network function registration request from each of the plurality of network functions includes information describing a location of each of the plurality of network functions; receiving dynamic load information for at least one of the plurality of network functions; receiving a discovery request from a control plane network function to discover one of the plurality of network functions, the discovery request including information describing a location of the control plane network function; determining a distance between the control plane network function and each of the plurality of network functions; and in response to the determining the distance, and in response to the dynamic load information, providing an identity of one of the plurality of network functions to the control plane network function.

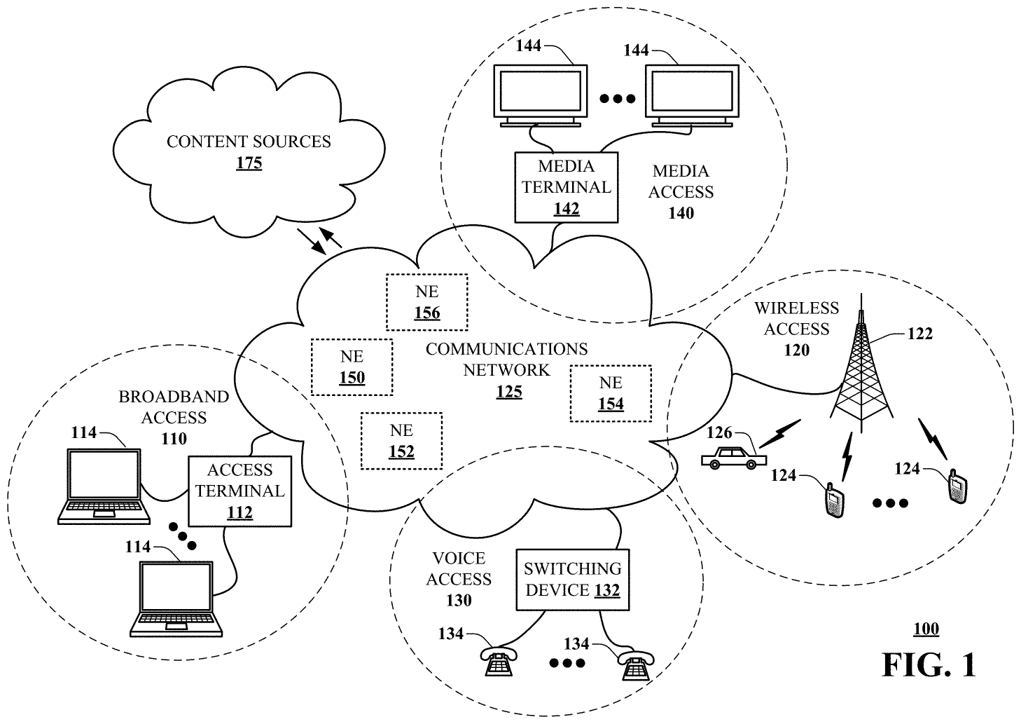

Referring now to FIG. 1, a block diagram is shown illustrating an example, non-limiting embodiment of a communications network 100 in accordance with various aspects described herein. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network. Network elements (NE) are also referred to herein as network functions (NF).

In various embodiments, network functions within communications network 125 may be selected based on dynamic load information and/or location. For example, a network repository function may receive dynamic load information for one or more network functions and the network repository function may satisfy a discovery request from a requesting network function based on the dynamic load information. Also for example, the network repository function may determine distances between the requesting network function and the one or more network functions, and may satisfy the request by selecting a network function closest to the requesting network function. These and other embodiments are described further below with reference to later figures.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

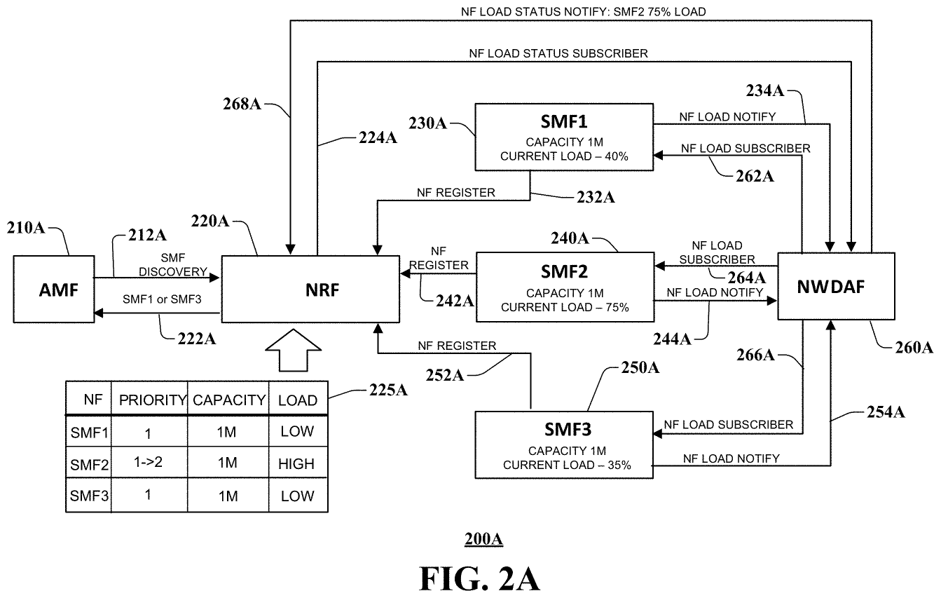

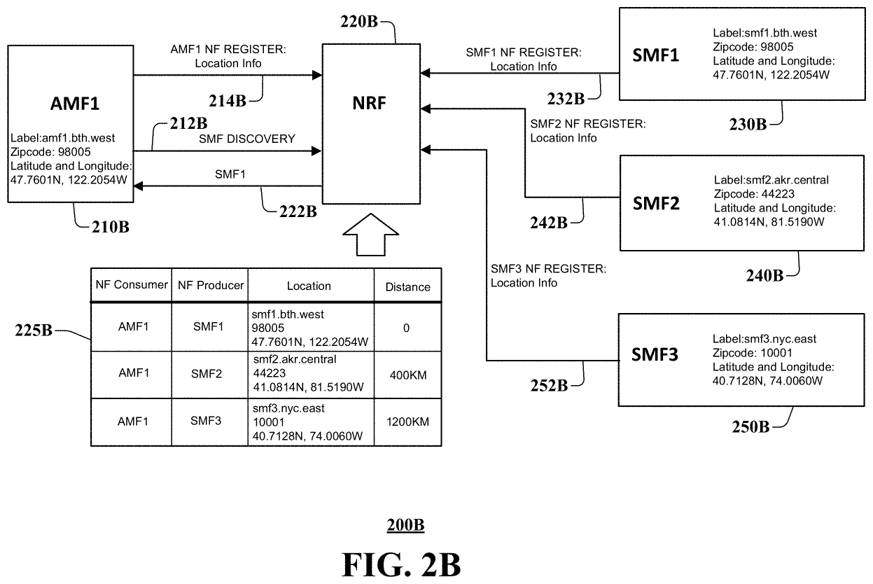

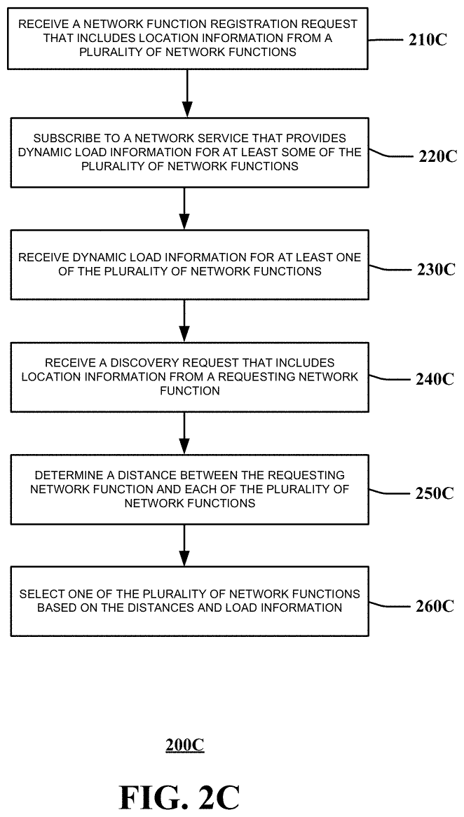

FIG. 2A is a block diagram illustrating an example, non-limiting embodiment of a system functioning within the communication network of FIG. 1 in accordance with various aspects described herein. System 200A shows access and mobility management function (AMF) 210A, network repository function (NRF) 220A, session management functions 230A (SMF 230A), 240A (SMF 240A), and 250A (SMF 250A), and network data analytics function (NWDAF) 260A. In various embodiments, when a first network function (e.g., AMF 210A) requests discovery of a second network function (e.g, an SMF such as SMF 230A, SMF 240A, or SMF 250A) from a third network function (e.g., NRF 220A), the third network function determines a candidate network function from the set of second network functions based at least in part on dynamic load conditions of the second network functions. These and other embodiments are described below.

In operation, network repository function (NRF) 220A maintains profiles of other network function instances and their supported services, and supports service discovery requests. For example, SMF 230A, SMF 240A, and SMF 250A are session management function instances that register with NRF 220A when they are created, or when they otherwise become available for discovery. This is shown at 232A where SMF 230A registers with NRF 220A, at 242A where SMF 240A registers with NRF 220A, and at 252A where SMF 250A registers with NRF 220A. In some embodiments, the network function registering with NRF 220A provides a network function (NF) profile that includes static capacity information indicating a maximum capacity of the registering network function. For example, each of SMF 230A, SMF 240A, and SMF 250A are shown having a capacity of 1M units, where the units may represent any measure of capacity. In these embodiments, when SMF 230A registers with NRF 220A, the static capacity information indicating a capacity of 1M is provided at 232A. Similar operations occur when SMF 240A registers at 242A and when SMF 250A registers at 252A.

In some embodiments, SMF 230A, SMF 240A, and SMF 250A implement a service (referred to herein as the “NF LOAD” service) that provides dynamic load information to other network functions that subscribe to the service. For example, a network function such as NWDAF 260A may, at 262A, subscribe to the NF LOAD service implemented by SMF 230A, and may similarly subscribe to NF LOAD services implemented by SMF 240A and SMF 250A at 264A and 266A, respectively. The NF LOAD service provides dynamic load information to subscribing network functions as shown by the NF LOAD NOTIFY interactions at 234A, 244A, and 254A.

In some embodiments, the NF LOAD service provides dynamic load information to the subscribing network function on a periodic basis. For example, in various embodiments, when subscribing to an NF LOAD service, a subscribing network function may specify an update interval, and the service may provide load information at the specified time intervals. Further, in some embodiments, the NF LOAD service provides dynamic load information when certain triggers are satisfied. For example, in various embodiments, when subscribing to an NF LOAD service, a subscribing network function may specify a trigger such as a dynamic load threshold, that when exceeded, will trigger an NF LOAD NOTIFY update. In some embodiments, the dynamic load threshold is specified as an absolute dynamic load value, and in other embodiments, the dynamic load threshold is specified as a load percentage. In these embodiments, the load percentage may represent the dynamic load as a percentage of the static capacity of the network function. Example thresholds may include 70% representing minor congestion, 80% representing medium congestion, and 90% representing severe congestion. In some embodiments, a trigger may be satisfied if a threshold is exceeded for a specified number of time intervals, or if an average load value is exceeded over a specified number of time intervals. For example, a trigger may be satisfied if a dynamic load value exceeds 80% over three intervals, or if an average dynamic load value exceeds 70% over five intervals.

In operation, NWDAF 260A supports the collection of data from various network functions and also supports services to provide data to subscribing network functions. For example, in some embodiments, NWDAF 260A collects dynamic load information from network functions such as SMF 230A, SMF 240A, and SMF 250A by subscribing to NF LOAD services implemented by those network functions.

In some embodiments, NWDAF 260A specifies an update interval to receive dynamic load information. For example, when subscribing to the NF LOAD service implemented by SMF 230A, NWDAF 260A may specify an update interval at 262A. The update interval may be in units of time. For example, NWDAF 260A may specify an update interval of one minute or ten minutes in which case SMF 230A will provide dynamic load information at 234A every one minute or every ten minutes, respectively. The various aspects disclosed herein are not limited by the duration of the update interval. For example, in some embodiments, very small update intervals are specified, and in other embodiments, very large update intervals are specified.

In some embodiments, NWDAF 260 specifies a condition, that when triggered, causes the dynamic load update. For example, NWDAF 260A may specify a trigger condition based on a particular load condition. Load conditions that may trigger an update include, but are not limited to, an absolute load threshold, a percentage load threshold, or any other dynamic load condition capable of being specified when NWDAF 260A subscribes to the NF LOAD service of a network function. Also for example, NWDAF 260A may specify a condition in addition, or in lieu of, a load condition to trigger an update by the NF LOAD service. Example trigger conditions include the addition of an SMF to a network slice instance, a change in the number of user plane functions (UPF) being managed by a particular SMF, or any other condition that may be specified when NWDAF 260A subscribes to the NF LOAD service of a network function.

In some embodiments, the NF LOAD service supports the specification of different trigger conditions based on other network states. For example trigger conditions may be made a function of the current network slice instance, slice/service types, the data network name (DNN) of the current connection, the current protocol data unit (PDU) session, PDU session type, or any other network state that may be specified when NWDAF 260A subscribes to the NF LOAD service of a network function.

In some embodiments, the dynamic load information that is provided by the NF LOAD service may be a global dynamic load value. For example, the dynamic load information provided by SMF 230A may represent the entire dynamic load of SMF 230A, regardless of network slice instance, DNN, UE, or any other non-global parameter. In other embodiments, the dynamic load information that is provided by the NF LOAD service may be a non-global dynamic load value. For example, SMF 230A may provide services in more than one network slice instance, and the dynamic load information provided by SMF 230A may represent the dynamic load for a particular network slice instance. Also for example, the dynamic load information may represent the dynamic load of all common PDU session types, all connections to a particular DNN, or the like.

NWDAF 260A may implement a service to provide dynamic load status information to a subscribing network function. In the example of FIG. 2A, NRF 220A subscribes to the NF LOAD STATUS service provided by NWDAF 260A at 224A. Similar to the NF LOAD service implemented by the example session management functions in FIG. 2A, the NF LOAD STATUS service implemented by NWDAF 260A may support periodic updates and triggered updates based on any criteria. In some embodiments NWDAF 260A exposes, via the NF LOAD STATUS service, all data collected by the various NF LOAD subscriptions. In the example of FIG. 2A, NRF 220A receives dynamic load updates that represent the dynamic loads of SMF 230A, SMF 240A, and SMF 250A. As a specific non-limiting example, NRF 220A is shown receiving an NF LOAD STATUS notification that SMF 240A has triggered an update by crossing a 75% dynamic load.

NRF 220A may maintain a status table 225A in memory or other storage that reflects the current load state of various network functions. For example, table 225A shows entries for SMF 230A, SMF 240A, and SMF 250A, each with a static load capacity of 1M. These entries may be established when each network function registers with NRF 220A as described above. Table 225A may also maintain load information and relative priorities of registered network functions. For example, table 225A includes a priority value of “1” for each of SMF 230A, SMF 240A, and SMF 250A, and then modifies the priority of SMF 240A to “2” as a result of receiving the NF LOAD STATUS notification that SMF 240A has a dynamic load of 75%. Similarly, SMF 230A and SMF 250A have “low” load and SMF 240A has “high” load based as a result of receiving the NF LOAD STATUS notification that SMF 240A has a dynamic load of 75%. The change in priority value and/or the “high” load value represent an indication that SMF 240A is congested. When the status of a previously congested NF is improved and drops below a threshold, NWDAF 260A may notify NRF 220A, and NRF 220A may adjust the load and priority in table 225A accordingly, thereby signifying that the NF is available once again as a candidate NF based on dynamic load information.

Table 225A and the values maintained within table 225A are provided as examples, and the various embodiments are not limited to the examples shown. For example, load values may include numeric entries, and priorities may be specified with finer granularity.

NRF 220A may use dynamic load data received at 268A and/or data maintained in table 225A in support of network function discovery and/or network function service discovery. For example, AMF 210A may initiate an SMF discovery procedure (also referred to herein as a “discovery request”) by providing the type of NF requested (in this example, SMF), and NRF 220A may determine a candidate SMF or a list of candidate SMFs to provide to AMF 210A based at least in part on dynamic load data. For example, as shown at 222A, NRF 220A provides a list of candidate SMFs that includes SMF 230A or SMF 250A because SMF 240A has a higher dynamic load.

In some embodiments, as part of a discovery request, a requesting network function provides to a network repository function a list of specific services it is attempting to discover. For example, AMF 210A may provide, as part of the SMF discovery request, a list of requested services that includes the NF LOAD service, thereby requesting an SMF that supports the dynamic load notification service. In these embodiments, NRF 220A may utilize the dynamic load information when determining candidate SMFs in response to the request that lists the NF LOAD service in the request. In other embodiments, AMF 210A initiates an SMF discovery request without specifying the NF LOAD service, and NRF 220A uses the dynamic load information to determine candidate SMFs even though the NF LOAD service was not listed in the request.

NRF 220A provides an identity of a candidate SMF or identities of multiple candidate SMFs to AMF 210A at 222A. The identity may be any type of identifying information (or grouping of identifying information) that allows the requesting network function to select or interact with a candidate network function. Examples include, but are not limited to: the IP address or fully qualified domain name (FQDN) of the candidate(s) and/or the endpoint address(es) of the candidate(s), or the like.

In the example of FIG. 2A, AMF 210A may initiate the SMF discovery request when a user entity (UE) (not shown) requests the establishment of a PDU session. One of the steps in establishing the PDU session includes AMF 210A discovering a session management function (SMF) to manage the session once established. This is the example communication shown in FIG. 2A.

Although FIG. 2A illustrates the use of dynamic load information in the context of discovering session management functions, the various embodiments are not limited in this manner. For example, any type of network function may register with a network repository function and implement an NF LOAD service, and any type of network function may initiate a discovery request that is satisfied using dynamic load information. The example of FIG. 2A shows a control plane function (AMF) requesting discovery of another control plane function (SMF). In other examples, a control plane function may request discovery of a user plane function (UPF), a UPF may request discovery of a control plane function, or a UPF may request discovery of another UPF.

FIG. 2A has been described using 5G nomenclature, however the various embodiments are not limited to 5G systems. For example, in 4G embodiments, the functionality of AMF 210A may be provided by a mobility management entity (MME), the functionality of the session management functions may be implemented as serving gateways and packet data network gateways, and the selection of gateways may incorporate dynamic load information as described above. Also for example, in some embodiments, including in systems beyond 5G, the devices and functionality described herein may be implemented in network elements having different names and acronyms.

FIG. 2B is a block diagram illustrating an example, non-limiting embodiment of a system functioning within the communication network of FIG. 1 in accordance with various aspects described herein. In various embodiments, when a first network function (e.g., AMF 210B) requests discovery of a second network function (e.g, an SMF such as SMF 230B, SMF 240B, or SMF 250B) from a third network function (e.g., NRF 220B), the third network function determines a distance between the requesting network function (e.g., AMF 210B) and each of the second network functions, and determines a candidate network function from the set of second network functions based at least in part on the distances. These and other embodiments are described below.

In operation, network repository function (NRF) 220B maintains profiles of other network function instances and their supported services, and supports service discovery requests. For example, SMF 230B, SMF 240B, and SMF 250B are session management function instances that register with NRF 220B when they are created, or when they otherwise become available for discovery. This is shown at 232B where SMF 230B registers with NRF 220B, at 242B where SMF 240B registers with NRF 220B, and at 252B where SMF 250B registers with NRF 220B. In some embodiments, the network function registering with NRF 220B provides a network function (NF) profile that includes location information indicating a physical location at which, or an area in which, the network function is implemented and/or deployed. For example, in some embodiments, each of SMF 230B, SMF 240B, and SMF 250B are virtual network functions that are implemented on one or more computer servers. In these embodiments, the location information associated with each SMF may represent the location of the server that implements the virtual network function.

Location information may be represented in any manner. For example, in some embodiments, location information is represented by a postal zip code. Also for example, in some embodiments, location information is represented by latitude and longitude values. Also for example, in some embodiments, location information is represented by an identifier such as a network function label that represents, or may be mapped to, a location. As an example, SMF 230B is shown being located in zip code 98005, being located at latitude 47.7601N, longitude 122.2054W, and having a network function label in a pointer.set.region format equal to smfl.bth.west. Also for example, SMF 240B is shown being located in zip code 44223, being located at latitude 41.0814N, longitude 81.5190W, and having a network function label in a pointer.set.region format equal to smf2.akr.central. Also for example, SMF 250B is shown being located in zip code 10001, being located at latitude 40.7128N, longitude 74.0060W, and having a network function label in a pointer.set.region format equal to smf3.nyc.east.

In the example of FIG. 2B, each of SMF 230A, SMF 240A, and SMF 250A are shown having a capacity of 1M units, where the units may represent any measure of capacity. In these embodiments, when SMF 230A registers with NRF 220A, the static capacity information indicating a capacity of 1M is provided at 232A. Similar operations occur when SMF 240A registers at 242A and when SMF 250A registers at 252A.

In some embodiments, each of SMF 230B, SMF 240B, and SMF 250B provides NF profile information that includes location information to NRF 220B when registering. For example, SMF 230B provides location information to NRF 220B at 232B when registering, SMF 240B provides location information to NRF 220B at 242B when registering, and SMF 250B provides location information to NRF 220B at 252B when registering. The location information provided when registering may include any type of information that identifies the location of the registering network function. Examples in include, but are not limited to, zip codes, network function labels, and lat/long values.

NRF 220B may maintain a status table 225B in memory that reflects the location of various network functions. For example, table 225B shows entries for SMF 230B, SMF 240B, and SMF 250B, each having the location information that was provided during registration.

NRF 220B may use location information maintained in table 225B in support of network function discovery and/or network function service discovery. For example, AMF 210B may initiate an SMF discovery procedure or SMF discovery request by providing the type of NF requested (in this example, SMF), and NRF 220B may determine a candidate SMF or a list of candidate SMFs to provide to AMF 210B based at least in part on the locations of the registered SMFs.

In some embodiments NRF 220B determines a candidate network function or a list of candidate network functions based at least in part on both the location of the requesting network function and the location of the registered network functions. For example, in some embodiments, the requesting network function registers with NRF 220B, and provides location information as part of the NF profile information. In the example of FIG. 2B, this is shown at 214B, where AMF 210B registers with NRF 220B, and provides location information. AMF 210B is shown having a zip code of 98005, a lat/long pair of 47.7601N/122.2054W, and a network function label equal to amfl.bth.west. Any type of location information may be provided to NRF 220B during registration, including but not limited to the values shown in FIG. 2B.

In some embodiments, NRF 220B determines a distance between the requesting network function and other registered network functions. For example, as shown in table 225B, NRF 220B determines that the distance between AMF 210B and SMF 230B is zero kilometers (KM), the distance between AMF 210B and SMF 240B is 400 KM, and the distance between AMF 210B and SMF 250B is 1200 KM.

In some embodiments, when AMF 210B provides an SMF discovery request at 212B, NRF 220B consults table 225B to determine a candidate network function. For example, NRF 220B may find a candidate network function having the smallest distance listed in table 225, corresponding to the candidate network function that is geographically closest to the requesting network function. In the example of FIG. 2B, NRF 220B determines that SMF 230B may be the sole candidate network function based on the distance value of zero KM.

In some embodiments, a list of candidate network functions is generated based at least in part on distance values. For example, a threshold distance may be set, and all registered network functions having a distance less than the threshold are included in the list of candidate network functions. Also for example, the candidate list of network functions may be based on which hardware servers implement the network functions, the data center in which the servers are located, or any other criteria.

In some embodiments, AMF 210B provides the location information when requesting discovery. For example, AMF 210B may provide location information for each discovery request at 212B. This may be in addition to, or in lieu of, providing location information during registration at 214B.

NRF 220B provides an identity of a candidate SMF or identities of multiple candidate SIVIFs to AMF 210B at 222B. The identity may be any type of identifying information (or grouping of identifying information) that allows the requesting network function to select or interact with a candidate network function. Examples include but are not limited to the IP address or fully qualified domain name (FQDN) of the candidate(s) and/or the endpoint address(es) of the candidate(s), or the like.

In the example of FIG. 2B, AMF 210B may initiate the SMF discovery request when a user entity (UE) (not shown) requests the establishment of a PDU session. One of the steps in establishing the PDU session includes AMF 210B discovering a session management function (SMF) to manage the session once established. This is the example communication shown in FIG. 2B. In some embodiments, NRF 220B utilizes the location information based on network slice instance, DNN, or any other network connection or state. For example, a particular class of UE or connection type may be given priority to access location dependent network function discovery. Also for example, if location dependent network function discovery is enabled, NRF 220B may ignore other priority settings and put location preference as the highest priority and respond to the discovery request with geographically closest candidate NFs to the requesting NF.

Although FIG. 2B illustrates the use of network function location information in the context of discovering session management functions, the various embodiments are not limited in this manner. For example, any type of network function may provide location information when registering with a network repository function, and any type of network function may initiate a discovery request that is satisfied using network function location information. The example of FIG. 2b shows a control plane function (AMF) requesting discovery of another control plane function (SMF). In other examples, a control plane function may request discovery of a user plane function (UPF), a UPF may request discovery of a control plane function, or a UPF may request discovery of another UPF.

FIG. 2B has been described using 5G nomenclature, however the various embodiments are not limited to 5G systems. For example, in 4G embodiments, the functionality of AMF 210B may be provided by a mobility management entity (MME), the functionality of the session management functions may be implemented as serving gateways and packet data network gateways, and the selection of gateways may incorporate network function location information as described above. Also for example, in some embodiments, including in systems beyond 5G, the devices and functionality described herein may be implemented in network elements having different names and acronyms.

In some embodiments, network function selection and discovery is based on both network function dynamic load information and network function location information. For example, in some embodiments, network functions provide static capacity information as well as location information as part of the NF profile when registering with a network repository function. The NRF may maintain a data structure in memory or other storage that includes location-based information as well as dynamic load information. For example, a NRF may maintain both tables 225A (FIG. 2A) and 22B (FIG. 2B), or may maintain a single table that includes the appropriate information.

When satisfying a discovery request, a NRF may determine a candidate network function or a list of candidate network functions based on location information and load information, and in any order. For example, in some embodiments, a NRF, when satisfying a discovery request, may first produce a first list of network functions that are within a certain distance of the requesting network function, and then determine candidate network functions from the first list based on dynamic load of the network functions in the first list. Also for example, in some embodiments, a NRF, when satisfying a discovery request, may first produce a first list of network functions based on dynamic load information, and then determine candidate network functions from the first list based on distances between the requesting network function and network functions in the first list.

FIG. 2C depicts an illustrative embodiment of a method in accordance with various aspects described herein. Method 200C begins at 210C in which a network function registration request that includes location information is received from a plurality of network functions. In some embodiments, the location information is provided along with other information, that when taken together, forms a network function profile. In some embodiments, the location information represents the location of the network function requesting registration. For example, a network function such as a session management function may provide location information as a zip code, latitude and longitude values, or a network function label. Examples are shown in FIG. 2B, where SMF 230B provides location information while registering at 232B, SMF 240B provides location information while registering at 242B, and SMF 250B provides location information while registering at 252B.

In some embodiments, the plurality of network functions requesting registration are control plane functions such as session management functions or other types of control plane functions. In other embodiments, the plurality of network functions requesting registration are user plane functions. The type of network functions providing location information while requesting registration is not a limitation of the various embodiments as described herein.

At 220C, a network service that provides dynamic load information for at least some of the plurality of network functions is subscribed to. In some embodiments, this is performed by a network repository function subscribing to a network function load status service provided by another network function, such as NWDAF 260A (FIG. 2A). In some embodiments, the subscription to network function load status updates specifies when and under what conditions a notification of network function load status is provided. For example, in some embodiments, the subscription to the network function load status service specifies a periodic update of dynamic load status of the plurality of network functions. Also for example, in other embodiments, the subscription to the network function load status service specifies a trigger which, when satisfied, causes an updated network function load status to be provided. Examples are provided with respect to FIG. 2A where NRF 220A subscribes to a network function load status service provided by NWDAF 260A at 224A, and NWDAF 260A provides network function load status notifications to NRF 220A at 268A.

At 230C, dynamic load information for at least one of the plurality of network functions is received. In some embodiments, the dynamic load information is expressed as an absolute load value, and in other embodiments, the dynamic load information is expressed as a percent load. In still further embodiments, the dynamic load information is provided as an absolute load value, and a static load capacity provided during network function registration is utilized to determine a percent load value.

In some embodiments, the dynamic load information his maintained in a table or other data structure in memory or other storage, and this information may be used to provide or determine candidate network functions in response to a network function discovery request. For example, as shown at 225A in FIG. 2A, the dynamic load status for each of the plurality of network functions may be maintained along with a priority derived from the dynamic load information.

At 240C, a discovery request is received from a requesting network function. In some embodiments, the discovery request may be received from a control plane function such as an AMF, and in other embodiments, the requesting network function may be a user plane function. Example requesting network functions are shown as AMF 210A (FIG. 2A) and AMF 210B (FIG. 2B). In some embodiments, the discovery request may include location information describing the geographic location of the requesting network function. For example, as shown in FIG. 2B, AMF 210B may include location information as part of SMF discovery request 212B. Also in some embodiments, location information may have already been provided by the requesting network function during a registration request as shown at 214B in FIG. 2B.

Also in some embodiments, the discovery request may include a list of services requested by the requesting network function. For example, the requesting network function may request a candidate network function that supports dynamic load status notification. Also for example, the requesting network function may request selection of a candidate network function based at least in part on the location of the network function or the geographic distance between the candidate network function and the requesting network function.

At 250C, a distance between the requesting network function and each of the plurality of network functions is determined. For example, in some embodiments, this corresponds to comparing zip codes of the requesting network function and the plurality of network functions. Also for example, in some embodiments this corresponds to comparing latitude and longitude values of the requesting network function and the plurality of network functions, and in still further embodiments, this may correspond to comparing network function labels of the requesting network function to network function labels of each of the plurality of network functions. An example of distance values is shown in table 225B (FIG. 2B).

At 260C, one or more of the plurality of network functions is selected based on the distances and load information. For example, a single candidate network function may be selected from the plurality of network functions based on the candidate network function having a small geographical distance to the requesting network function and having a load below a threshold. In some embodiments, network functions having distances below a first threshold are identified to produce a first list of candidate network functions and then one or more of those candidate network functions are selected from the first list based on dynamic load information. In other embodiments, the first list of candidate network functions is selected based on the dynamic load information, and then one or more candidate network functions is selected from that first list based on distances between the candidate network functions and the requesting network function. Once determined, the candidate network function or list of candidate network functions is provided to the requesting network function. In some embodiments, the identity of the list of candidate network functions is sent to the requesting network function where the identity may be any information capable of identifying the network function.

Various embodiments described herein provide for selection of network functions during discovery that provides for short geographical distances between network functions and selection of network functions having low or lower dynamic load values. In some embodiments the network function selection is based on both distance and dynamic load, and in other embodiments, network function selection is based on one of distance and dynamic load. For example, in some embodiments, network function selection is performed based on distances without taking into account dynamic load, and in other embodiments, network function selection is performed based on dynamic load without taking into account distances.

Various embodiments described herein may result in lower latency and higher quality of service which may be useful to a class of users or a type of network connection. For example, the various embodiments described herein may be utilized for networks serving first responders or emergency personnel. In some embodiments, information describing this class of users may be provided by the user entity when requesting session establishment, and in other embodiments, this information may be embedded in network slice instance and or data network name information corresponding to the session being established. Accordingly, the various embodiments described herein may be employed or not employed on a session basis, a network slice instance basis, a data network name basis, or any other basis

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

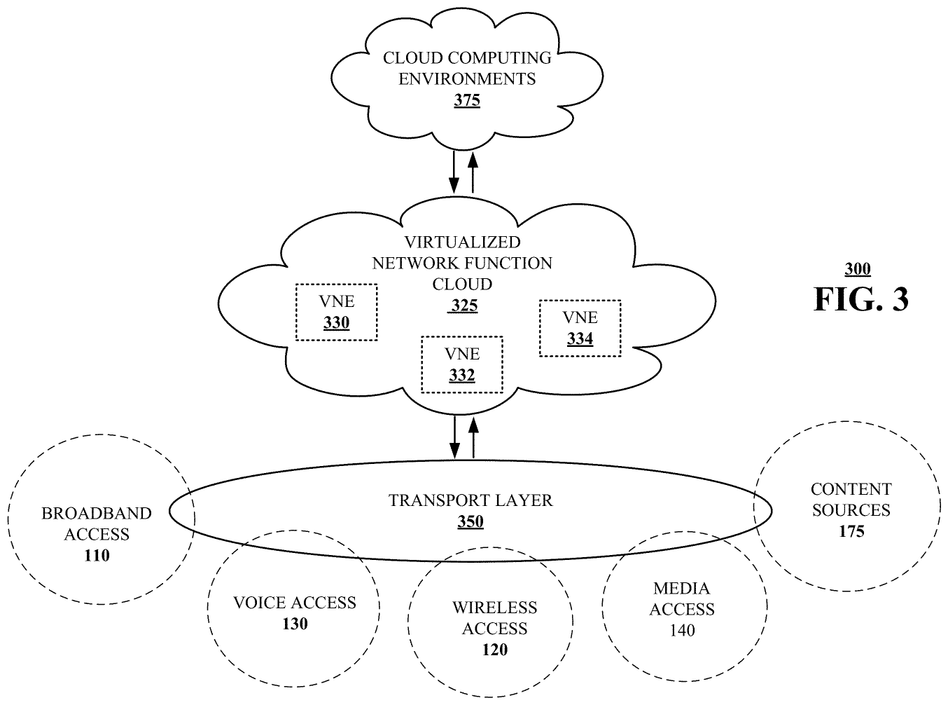

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of systems 200A, 200B, and method 200C presented in FIGS. 1, 2A, 2B, 2C, and 3. For example, virtualized communication network 300 can facilitate in whole or in part network function discovery based at least in part on network function location, distances between network functions, static load capacity of network functions, and/or dynamic load of network functions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

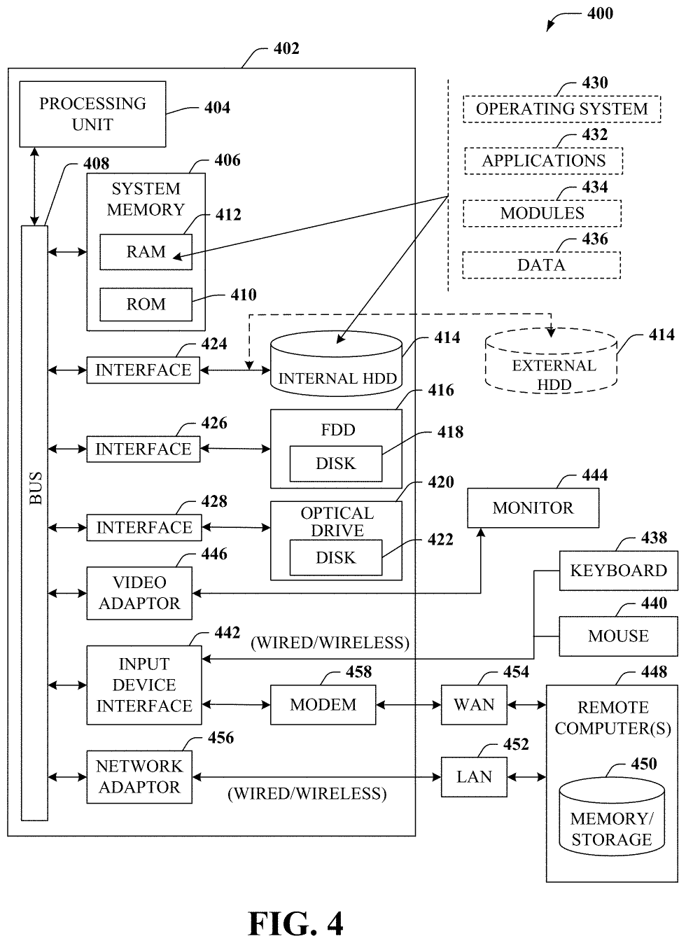

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part network function discovery based at least in part on network function location, distances between network functions, static load capacity of network functions, and/or dynamic load of network functions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

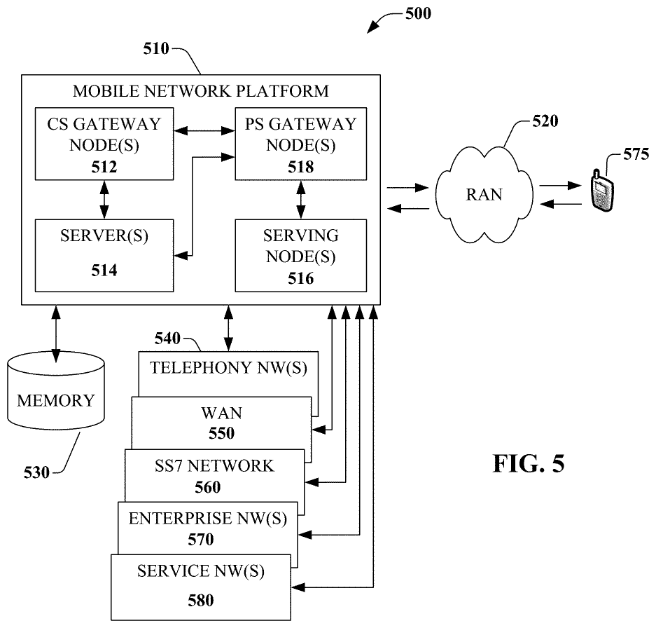

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part network function discovery based at least in part on network function location, distances between network functions, static load capacity of network functions, and/or dynamic load of network functions. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

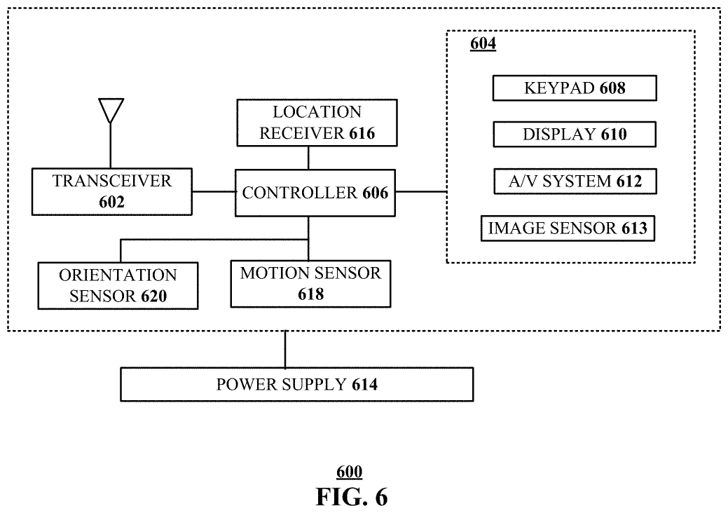

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part network function discovery based at least in part on network function location, distances between network functions, static load capacity of network functions, and/or dynamic load of network functions.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth ZigBee , WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
receiving a network function registration request from each of a plurality of network functions, wherein the network function registration request from each of the plurality of network functions includes information describing a location of each of the plurality of network functions;
receiving dynamic load information for at least one of the plurality of network functions;
receiving a discovery request from a control plane network function to discover one of the plurality of network functions, the discovery request including information describing a location of the control plane network function;
determining a distance between the control plane network function and each of the plurality of network functions; and
in response to the determining the distance, and in response to the dynamic load information, providing an identity of at least one of the plurality of network functions to the control plane network function.

2. The device of claim 1 wherein the receiving dynamic load information comprises receiving an indication that the at least one of the plurality of network functions is congested.

3. The device of claim 1 wherein the control plane network function comprises an access and mobility management function (AMF).

4. The device of claim 3 wherein the plurality of network functions comprises a plurality of session management functions (SMF).

5. The device of claim 1 wherein the plurality of network functions comprises a plurality of user plane functions (UPF).

6. The device of claim 1 wherein the device comprises a network repository function (NRF).

7. A non-transitory machine-readable medium comprising executable instructions that, when executed by a processing system including a processor, facilitate performance of operations, the operations comprising:
receiving a network function registration request from each of a plurality of network functions, wherein the network function registration request from each of the plurality of network functions includes information describing a location of each of the plurality of network functions;
receiving a discovery request from a control plane network function to discover one of the plurality of network functions, the discovery request including information describing a location of the control plane network function;
determining a distance between the control plane network function and each of the plurality of network functions; and
in response to the determining the distance, providing an identity of at least one of the plurality of network functions to the control plane network function.

8. The non-transitory machine-readable medium of claim 7 wherein the information describing the location of each of the plurality of network functions comprises a zip code.

9. The non-transitory machine-readable medium of claim 7 wherein the information describing the location of each of the plurality of network functions comprises a network function label.

10. The non-transitory machine-readable medium of claim 7 wherein the information describing the location of each of the plurality of network functions comprises a latitude value and a longitude value.

11. The non-transitory machine-readable medium of claim 7 wherein the plurality of network functions comprises control plane network functions.

12. The non-transitory machine-readable medium of claim 7 wherein the plurality of network functions comprises user plane network functions.

13. The non-transitory machine-readable medium of claim 7 wherein the operations further comprise subscribing to a network service that provides a dynamic load information for each of the plurality of network functions.

14. The non-transitory machine-readable medium of claim 13 wherein the providing the identity of one of the plurality of network function is in response to the dynamic load information for each of the plurality of network functions.

15. The non-transitory machine-readable medium of claim 14 wherein the receiving the network function registration request comprises receiving static load capacity information, and wherein the providing the identity of at least one of the plurality of network functions is in response to the dynamic load information and the static load capacity information for each of the plurality of network functions.

16. A method comprising:
receiving, by a processing system including a processor, a network function registration request from each of a plurality of network functions;
subscribing, by the processing system, to a network service that provides a dynamic load information for each of the plurality of network functions;
receiving, by the processing system, the dynamic load information for at least one of the plurality of network functions;
receiving, by the processing system, a discovery request from a control plane network function to discover one of the plurality of network functions;
selecting, by the processing system, a candidate network function from the plurality of network functions based on the dynamic load information received for the at least one of the plurality of network functions; and
providing, by the processing system, an identity of the candidate network function to the control plane network function.

17. The method of claim 16 wherein the subscribing comprises requesting the dynamic load information be provided when a network function's dynamic load increases beyond a threshold.

18. The method of claim 16 wherein the subscribing comprises requesting the dynamic load information be provided as a periodic update.

19. The method of claim 16 wherein the plurality of network functions comprises control plane network functions.

20. The method of claim 16 wherein the plurality of network functions comprises user plane network functions.
